(19) United States
(12) Patent Application Publication
(10) Pub. No.: US 2018/0211277 A1
(43) Pub. Date: Jul. 26, 2018

(54) LOCATION EVENT FORCED EXIT WITHIN A PROGRAM

(71) Applicant: International Business Machines Corporation, Armonk, NY (US)

(72) Inventors: Lisa Seacat DeLuca, Baltimore, MD (US); Scott H. Mitchell, Smyrna, GA (US)

(21) Appl. No.: 15/416,572

(22) Filed: Jan. 26, 2017

(51) Int. Cl. G06Q 30/02

(52) U.S. Cl. CPC G06Q 30/0252; G06Q 30/0261; G06Q 30/0259

(57) ABSTRACT

A second related location event within a marketing program is listened for by a listener after a first location event has occurred. If the second related location event occurs before the program exits, the program is moved to an exit state and any further processing regarding the program is disregarded.

### BACKGROUND

The present invention relates to location events, and more specifically to a location event forced exit within a program.

Venue location based events are growing in popularity. Many retailers are using the capabilities of Bluetooth low energy beacons to better understand their customer's movements. Data regarding the movements of the customers within a venue can be used to send real-time promotions and offers to customers that are personalized to a zone level as the customers move around in the venue.

Location events can be used to enhance current campaign capabilities. Currently it is possible for an event to be triggered and held in a campaign system for a period of time before it is actually sent, either as a defect with the system itself such as slow processing time or on purpose to limit message overload for end users. This can be problematic if a user receives a promotion or offer too late.

### SUMMARY

According to one embodiment of the present invention, a method of location event forced exit from a program of a campaign of promotions for a consumer in a venue is disclosed. The method comprising the steps of: a computer detecting a first location event triggered by a consumer in the venue; the computer enabling the campaign of promotions associated with the first location event; the computer detecting a second location event, different than the first location event, triggered by the consumer of the venue; the computer determining a status of the campaign of promotions associated with the first location event; and when the consumer is participating with an enabled campaign associated with the first location event when the user is detected by a triggered second event, the computer forcing an exit from the enabled campaign associated with the first location event.

According to another embodiment of the present invention, a computer program product for location event forced exit from a program of a campaign of promotions for a consumer in a venue is disclosed. The computer program product comprising: a computer comprising at least one processor, one or more memories, one or more computer readable storage media, the computer program product comprising a computer readable storage medium having program instructions embodied therewith, the program instructions executable by the computer to perform a method comprising: detecting, by the computer, a first location event triggered by a consumer in the venue; enabling, by the computer, the campaign of promotions associated with the first location event; detecting, by the computer, a second location event, different than the first location event, triggered by the consumer of the venue; determining, by the computer, a status of the campaign of promotions associated with the first location event; and when the consumer is participating with an enabled campaign associated with the first location event when the user is detected by a triggered second event, forcing, by the computer, an exit from the enabled campaign associated with the first location event.

According to an embodiment of the present invention, a computer system for location event forced exit from a program of a campaign of promotions for a consumer in a venue is disclosed. The computer system comprising a computer comprising at least one processor, one or more memories, one or more computer readable storage media having program instructions executable by the computer to perform the program instructions comprising: detecting, by the computer, a first location event triggered by a consumer in the venue; enabling, by the computer, the campaign of promotions associated with the first location event; detecting, by the computer, a second location event, different than the first location event, triggered by the consumer of the venue; determining, by the computer, a status of the campaign of promotions associated with the first location event; and when the consumer is participating with an enabled campaign associated with the first location event when the user is detected by a triggered second event, forcing, by the computer, an exit from the enabled campaign associated with the first location event.

### BRIEF DESCRIPTION OF THE SEVERAL VIEWS OF THE DRAWINGS

FIG. 1 depicts a cloud computing node according to an embodiment of the present invention.

FIG. 2 depicts abstraction model layers according to an embodiment of the present invention.

FIG. 3 shows a flow diagram of a method of location event forced exit from a program of a campaign of promotions for a consumer.

FIG. 4 shows a schematic of a venue and a consumer's path.

### DETAILED DESCRIPTION

Currently it is not possible to force a user out of a program for marketing campaigns when a micro-location event is triggered.

In some the prior art, a send engine, responsible for actually sending all out bound messages (email, SMS, or push notifications), may use suppression rules to take users that have preliminarily been targeted to receive a message and run them through a set of business rules to prevent inappropriate message sending. For example, suppression rules can be utilized to ensure that a single user doesn't receive more than a specified number of messages in a given time window. However, there are not any location based suppression rules currently available and once the software program is entered, it is not possible to force the user out of the program.

In embodiments of the present invention, a second related location event within a marketing program is listened for by a listener after a first location event has occurred. If the second related location event occurs before the program exits, the program is moved to the exit state and any further processing regarding the program is disregarded.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

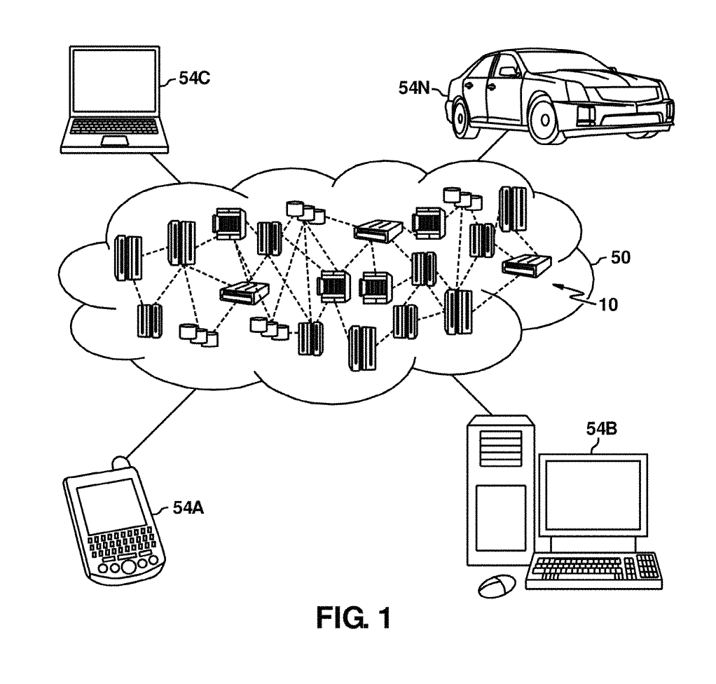

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer MB, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

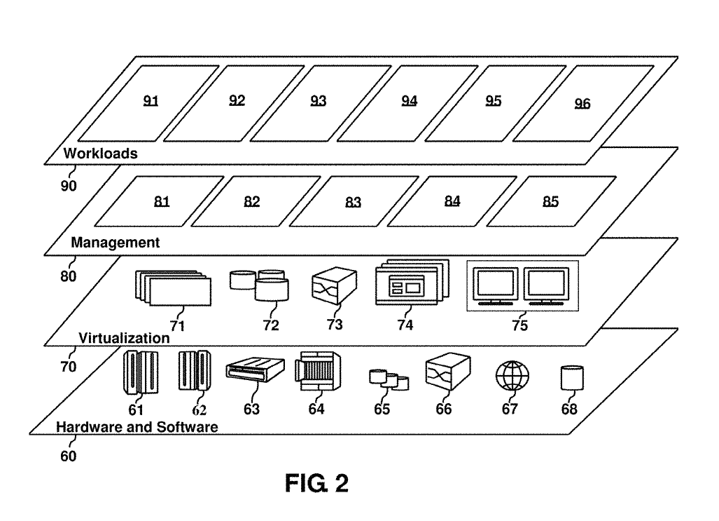

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and location event management 96.

In embodiments of the present invention, a venue is configured for monitoring of a plurality of location events. The location events may be managed through a location event management system 96. The location event management system 96 can monitor for location events of the venue, such as zone entry, zone exit, zone dwell, geo entry, geo exit, and geo dwell. A program of a campaign is created and triggered based on a first location event detected for a consumer or user, for example zone entry. The campaign comprises a conditional “listener” which is only associated with the campaign and waits for a second location event of the consumer to occur. The user enters the program for the campaign when the first location event is triggered. When a second location event is detected, the location event management system 96 looks up the consumer's current program status. If the consumer is still within the program, the consumer is kicked out of the program.

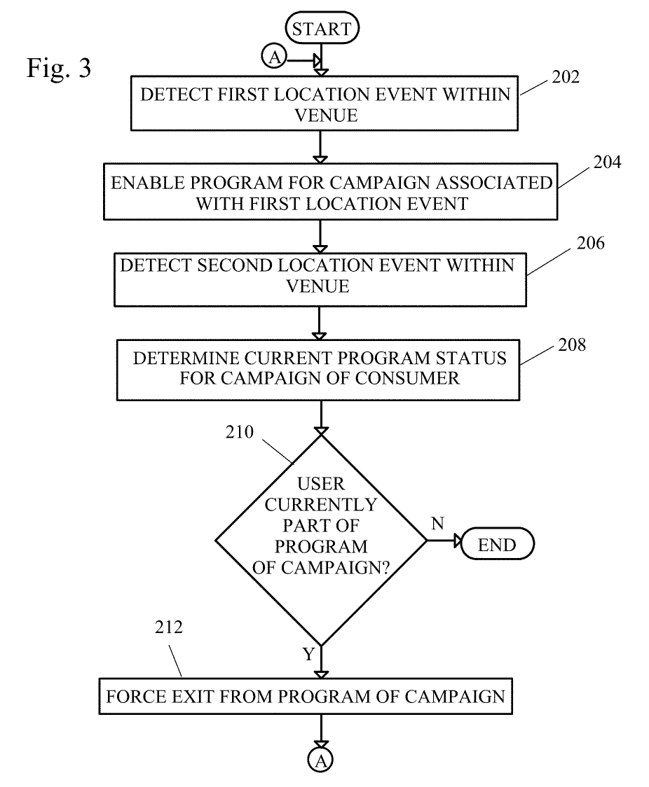

Prior to the method of FIG. 3, a venue is configured for location events and a location management system 96 with associated campaign tools to consume location events is implemented. The associated campaign tools preferably include a listener for location events and a campaign to be executed based on specific location events. The program of the campaigns may be stored in a lookup table, repository, database or other storage.

FIG. 3 shows a flow diagram of a method of location event forced exit from a program of a campaign of promotions for a consumer.

In a first step, a first location event of a consumer at a venue is detected (step 202), for example by the listener of the location management system 96. The location event may be any event configured for the venue.

The program for the campaign associated with first location event is enabled (step 204). More specifically, the consumer which triggered the first location event is entered into the campaign of promotions, such that messages or offers associated with the campaign can be sent to the consumer. The program for the campaign may send a promotion which includes a coupon, for example a percentage off of a product, and/or an offer, such as buy two get one free as a notification to a consumer within a zone of the venue.

A second location event of a same consumer at a venue is detected (step 206), for example by the listener of the location management system 96. The location event may be any event configured for the venue other than the first location event.

The status of the current program of the campaign of the consumer is determined (step 208). The status of the current program of the campaign may be present in a lookup table maintained by the location management system 96.

If the consumer is currently part of a program of a campaign (step 210), the location management system 96 forces an exit of the program of the campaign (step 212) and the method returns to step 202 of detecting a first location event.

If the consumer is not currently part of a program of a campaign (step 210), no action is taken and the method ends, since the promotion of the program of the campaign has already been sent to the consumer.

It should be noted that if a location exit event (e.g. exiting of the venue occurs) is completed before processing of the campaign is completed, the promotion is not sent and the method ends.

Example Use Case

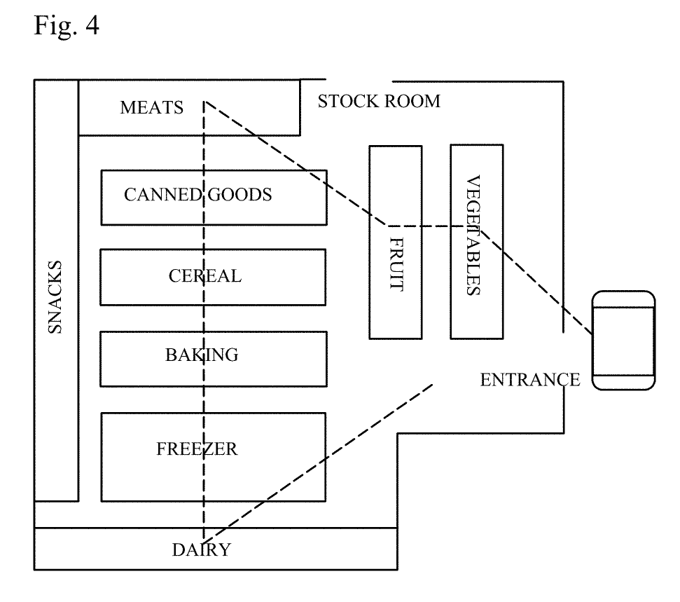

A consumer has entered a supermarket venue to pick up a few things for dinner. The path of the consumer is shown by the dashed line in FIG. 4. Because the consumer is moving through the supermarket quickly, the consumer has triggered a number of zone events. In this case consumer's actions triggered the following zone events: 1) vegetables entry; 2) vegetables exit; 3) fruit entry; 4) fruit exit; 5) meats entry; 6) meats exit; 7) canned goods entry; 8) canned goods exit; 9) cereal entry; 10) cereal dwell 5 minutes; 11) cereal exit; 12) baking entry; 13) baking exit; 14) freezer entry; 15) freezer exit; 16) dairy entry and 17) dairy exit.

Conventionally, the consumer's movement would have triggered an event for each zone and the consumer would therefore see numerous notifications of promotions, some of which would come after the consumer exits the applicable zone. For example, the consumer may receive a notification of a promotion for fruit when the consumer has triggered a location event for baking.

In embodiments of the present invention, the location management system 96 would recognize that the user exited many of the zones soon after the consumer entered them, such that notifications would never be sent. Even though the consumer would have triggered an event to cause entry of the consumer with the program of the campaign, as soon as an exit event was received, location management system 96 would force exit the consumer from the program of the campaign if a notification of a promotion had not already been sent to the consumer's device.

If the consumer were to spend more time in a specific zone, for example the cereal zone as described above, a single notification of a promotion, for example a coupon for an item in the cereal zone (10% off whole grain cereals) is sent to the consumer. It should be noted that if the consumer moved through all of the zones of the supermarket without any dwell time, no notifications would be sent as opposed to the prior art where the notifications would have been sent for zones after the consumer had already left the applicable zone or possibly the venue.

Certain embodiments of the present invention reduce the load of a processor of the location management system, since programs are preventing from stalling and running when no longer applicable to consumers. This reduces processor load and increasing the efficiency of the location management system.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory

(RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of location event forced exit from a program of a campaign of promotions for a consumer in a venue comprising the steps of:
a computer detecting a first location event triggered by a consumer in the venue;
the computer enabling the campaign of promotions associated with the first location event;
the computer detecting a second location event, different than the first location event, triggered by the consumer of the venue;
the computer determining a status of the campaign of promotions associated with the first location event; and
when the consumer is participating with an enabled campaign associated with the first location event when the user is detected by a triggered second event, the computer forcing an exit from the enabled campaign associated with the first location event.

2. The method of claim 1, further comprising the step of the computer enabling the campaign of promotions associated with the second location event.

3. The method of claim 1, wherein the venue comprises designated location events.

4. The method of claim 1, further comprising the step of the computer sending a promotion associated with the first location event to the user.

5. The method of claim 1, wherein the campaign of promotions comprises at least one coupon associated with the first location event.

6. The method of claim 1, wherein the campaign of promotions comprises at least one offer to the consumer, associated with the first location event.

7. A computer program product for location event forced exit from a program of a campaign of promotions for a consumer in a venue, a computer comprising at least one processor, one or more memories, one or more computer readable storage media, the computer program product comprising a computer readable storage medium having program instructions embodied therewith, the program instructions executable by the computer to perform a method comprising:
detecting, by the computer, a first location event triggered by a consumer in the venue;
enabling, by the computer, the campaign of promotions associated with the first location event;
detecting, by the computer, a second location event, different than the first location event, triggered by the consumer of the venue;
determining, by the computer, a status of the campaign of promotions associated with the first location event; and
when the consumer is participating with an enabled campaign associated with the first location event when the user is detected by a triggered second event, forcing, by the computer, an exit from the enabled campaign associated with the first location event.

8. The computer program product of claim 7, further comprising the program instructions of enabling, by the computer, the campaign of promotions associated with the second location event.

9. The computer program product of claim 7, wherein the venue comprises designated location events.

10. The computer program product of claim 7, further comprising the program instructions of sending, by the computer, a promotion associated with the first location event to the user.

11. The computer program product of claim 7, wherein the campaign of promotions comprises at least one coupon associated with the first location event.

12. The computer program product of claim 7, wherein the campaign of promotions comprises at least one offer to the consumer, associated with the first location event.

13. A computer system for location event forced exit from a program of a campaign of promotions for a consumer in a venue, the computer system comprising a computer comprising at least one processor, one or more memories, one or more computer readable storage media having program instructions executable by the computer to perform the program instructions comprising:
detecting, by the computer, a first location event triggered by a consumer in the venue;
enabling, by the computer, the campaign of promotions associated with the first location event;
detecting, by the computer, a second location event, different than the first location event, triggered by the consumer of the venue;
determining, by the computer, a status of the campaign of promotions associated with the first location event; and
when the consumer is participating with an enabled campaign associated with the first location event when the user is detected by a triggered second event, forcing, by the computer, an exit from the enabled campaign associated with the first location event.

14. The computer system of claim 13, further comprising the program instructions of enabling, by the computer, the campaign of promotions associated with the second location event.

15. The computer system of claim 13, wherein the venue comprises designated location events.

16. The computer system of claim 13, further comprising the program instructions of sending, by the computer, a promotion associated with the first location event to the user.

17. The computer system of claim 13, wherein the campaign of promotions comprises at least one coupon associated with the first location event.

18. The computer system of claim 13, wherein the campaign of promotions comprises at least one offer to the consumer, associated with the first location event.
